(19) United States
(12) Patent Application Publication
(10) Pub. No.: US 2026/0091567 A1
(43) Pub. Date: Apr. 2, 2026

(54) METHOD AND APPARATUS FOR PRODUCING A CONTAINER WITH A SHELL MADE OF A FIBER-BASED MATERIAL WITH A FLANGE PORTION

(71) Applicant: OPTIMA consumer GmbH, Schwäbisch Hall (DE)

(72) Inventors: Julian Sturm, Schwäbisch Hall (DE); Dominik Bröllochs, Schwäbisch Hall (DE); Alex Abischew, Schwäbisch Hall (DE); Tobias Freiberger, Schwäbisch Hall (DE)

(73) Assignee: OPTIMA consumer GmbH, Schwäbisch Hall (DE)

(21) Appl. No.: 19/339,976

(22) Filed: Sep. 25, 2025

(30) Foreign Application Priority Data
Oct. 2, 2024 (DE) 102024128537.0

(51) Int. Cl. B31B 50/28; B31B 105/00; B31B 110/10; B31B 120/00

(52) U.S. Cl. CPC B31B 50/28; B31B 2105/00; B31B 2110/10; B31B 2120/002

(57) ABSTRACT

The invention relates to a method for manufacturing a container with a shell made of a fiber-based material, wherein the container has an open end with an opening and a closed end, wherein a flange section with a sealing surface is formed on the shell at the open end, comprising the steps: preforming the flange section by forming a spiral winding by rolling a free edge section of the shell outward, and finishing the flange section by flattening the spiral winding with an ultrasonic device comprising an ultrasonic sonotrode and an anvil, wherein the ultrasonic sonotrode for flattening the spiral winding is arranged on a side of the spiral winding in the direction of the closed end and the anvil is arranged on an opposite side of the spiral winding. The invention further relates to a device for manufacturing the container.

### CROSS-REFERENCE TO RELATED APPLICATION

The present application claims priority to German Patent Application No. 102024128537.0, filed October 2, 2024, the entirety of which is incorporated herein by reference.

### FIELD OF APPLICATION AND PRIOR ART

The invention relates to a method and device for manufacturing a container with a shell made of a fiber-based material, wherein the shell has a flange section.

A fiber-based material is defined here as a material comprising at least one layer of a fibrous material, for example pulp, wood pulp, and/or waste paper pulp, in particular paper and/or cardboard. Due to their suitability for recycling, fiber-based materials are increasingly being used in the packaging industry, some of which are also obtained from already recycled materials.

The container is, for example, a so-called capsule, in particular a coffee capsule, which contains a substance used to make a beverage, in particular coffee.

The container has an opening at one end through which the container can be filled. After filling, the opening is sealed with a lid. The flange section serves in particular to attach the lid. It is particularly well known for coffee capsules that the lid remains connected to the container even when in use. For other applications, a lid is removed for use by a user.

To form the flange section, it is known to roll out a free edge section of the shell and then flatten the resulting roll or spiral winding.

JP2009184169 A2 shows a device for manufacturing a container with an opening and a flat flange section provided at the opening, the device comprising a cup holder with a support section, into which a container with a rolled edge section can be inserted in such a way that the rolled edge section rests on the support section. The device further comprises an ultrasonic sonotrode with a circumferential groove, which is fed to the container inserted in the container holder in order to flatten the rolled edge section.

### PROBLEM AND SOLUTION

The object of the invention is to provide an improved method and device for manufacturing a container having a shell made of a fiber-based material, wherein the shell has a flange section.

According to a first aspect, a method for manufacturing a container with a shell made of a fiber-based material is provided, wherein the container has an open end with an opening and a closed end, wherein a flange section with a sealing surface is formed on the shell at the open end, comprising the steps of: (a) preforming the flange section by forming a spiral winding by rolling a free edge section of the shell outward, and (b) finishing the flange section by flattening the spiral winding while applying ultrasonic vibrations with an ultrasonic device comprising an ultrasonic sonotrode and an anvil, wherein the ultrasonic sonotrode for flattening the spiral winding is arranged on a side of the spiral winding in the direction of the closed end, and the anvil is arranged on an opposite side of the spiral winding.

According to a second aspect, a device is provided for manufacturing a container having a shell made of a fiber-based material, wherein the container has an open end with an opening and a closed end, and wherein the shell has a flange section with a sealing surface at the open end of the container. The device comprises an ultrasonic device with an ultrasonic sonotrode and an anvil, wherein the ultrasonic device is designed to apply ultrasonic vibrations to the spiral winding for finishing the flange section by flattening the spiral winding, and wherein the ultrasonic device is designed such that the ultrasonic sonotrode for flattening the spiral winding is arranged on a side of the spiral winding in the direction of the closed end and the anvil is arranged on an opposite side of the spiral winding.

A spiral winding refers to a deformation in which a free edge section of the shell is deflected by at least 180°. When deflected by at least approximately 180°, a flange section with two layers is formed during flattening of the spiral winding. When deflected by at least approximately 360°, a single-turn spiral winding is formed, wherein a flange section with three layers is created when the spiral winding is flattened. In certain embodiments, it is envisaged that a free edge section is deflected by more than 360°, in particular by up to 540°. In certain embodiments, the deflection is by integer multiples of 180° in order to create a flange section with a corresponding number of layers.

The ultrasonic vibrations heat the material of the shell in the region of the spiral winding for flattening, thereby improving the formability of the fiber-based material. A region of the spiral winding that forms the later sealing surface of the flange section is pressed against the anvil during flattening. The design of the anvil’s pressing surface defines the shape of the sealing surface.

In certain embodiments, the shell is made of a multi-layered material comprising at least a first layer of a fibrous material and a sealing layer, wherein the sealing layer is arranged on an inner side of the shell, wherein the sealing layer is activated in an inner region when the spiral winding is flattened and remains in a region of the sealing surface. In advantageous embodiments, a spiral winding is formed during preforming, in which a free edge section is deflected by 360°, and/or a correspondingly preformed product is provided on a device so that a flange section with three layers is formed during flattening, wherein a middle layer serves to strengthen the flange section.

In certain embodiments, the sealing layer is only applied in certain regions. For easy manufacturing, the shell is made entirely of a multi-layered fiber-based material. The sealing layer in certain embodiments is made of a plastic, in particular a biodegradable plastic and/or a bio-based plastic and/or a thermoplastic. In this context, bio-based plastic refers to plastic that is made entirely or partially of biogenic raw materials, such as corn and sugar cane. In this context, biodegradable plastic refers to a plastic that decomposes under certain conditions and mainly leaves behind carbon dioxide and water when it breaks down.

Because the sealing layer remains intact in the region of the sealing surface, the sealing layer can be used directly to seal the shell to a lid or other membrane to seal the opening.

In certain embodiments, the material of the shell includes additional layers. In particular, in certain embodiments, the multi-layered fiber-based material has a single-layered or multi-layered barrier layer between the layer of fiber-based material and the sealing layer and/or on a side of the layer of fiber-based material facing away from the sealing layer. The barrier layer serves in particular as a barrier to oxygen, grease, oil, water, and/or water vapor.

Preforming of the flange section is carried out in certain embodiments in one step, also referred to as “in one go”, or in several steps. For forming or rolling in several steps, different rolling tools are used one after the other, particularly in certain embodiments.

In certain embodiments, the spiral winding is also preformed by applying ultrasonic vibrations. In particular, at least one rolling tool or at least one rolling tool in a plurality of rolling tools is designed as an ultrasonic sonotrode and/or is coupled to an ultrasonic sonotrode. The edge section to be deflected is heated by the applied ultrasonic vibrations, thereby improving the deformability of the edge section.

Alternatively or additionally, certain embodiments are provided in which the flange section is preformed using a heated rolling tool, wherein the rolling tool is heated to a temperature of approx. 40°C up to a maximum temperature that is lower than the glass transition temperature of the sealing layer, in particular lower than 80°C. Heating the rolling tool to a maximum temperature that is lower than the glass transition temperature of the sealing layer ensures that the sealing layer is not activated during preforming of the flange section.

The shell in certain embodiments is truncated cone-shaped or sleeve-shaped and is formed by overlapping and sealing two side edges of a flat blank.

In certain embodiments, the shell is truncated cone-shaped or sleeve-shaped and is formed by overlapping and sealing two side edges of a flat blank. In the case of a truncated cone-shaped shell, the diameter of the lower end of the shell is smaller than the diameter of the upper end of the shell, wherein the diameter of the contact surface of the base corresponds at least substantially to the diameter of the lower end of the shell. In a sleeve-shaped shell, the diameter of the lower end of the shell is at least substantially equal to the diameter of the upper end of the shell and the diameter of the contact surface of the base.

Depending on the embodiment, both the shell and the base are made of a fiber-based material. Depending on the application, the shell and base are made of the same or different materials.

### BRIEF DESCRIPTION OF THE DRAWINGS

Further advantages and aspects of the invention are apparent from the claims and from the description of exemplary embodiments of the invention, which are explained below with reference to the figures. For the sake of clarity, the figures are not shown to scale. Schematic representations show:

FIG. 1: an exemplary embodiment of a container made of a fiber-based material with an opening and a sealing surface at the opening;

FIG. 2: a first intermediate product in the manufacture of the container according to FIG. 1;

FIG. 3: a second intermediate product in the manufacture of the container according to FIG. 1 with a tool for forming a rolled edge; and

FIG. 4: the container according to FIG. 1 with a tool for finishing the sealing surface.

### DETAILED DESCRIPTION OF THE EXEMPLARY EMBODIMENTS

Uniform reference symbols are used in the following figures for identical or similar elements and/or components.

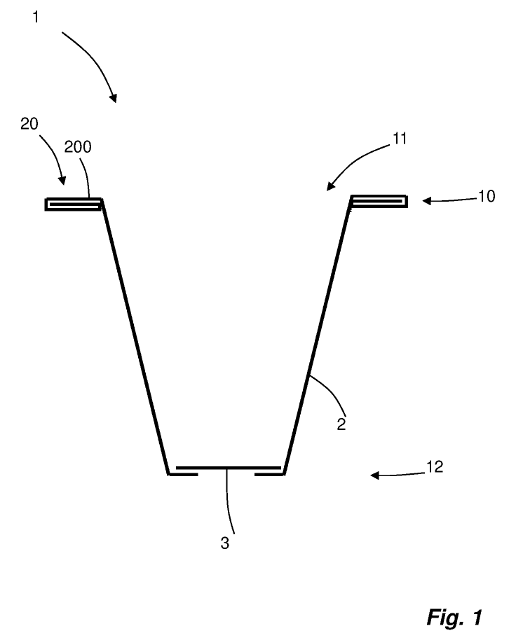

FIG. 1 schematically shows an exemplary embodiment of a container 1 made from a fiber-based material. The container 1 has an open end 10 with an opening 11 and a closed end 12.

The container 1 shown comprises a shell 2 and a base 3 arranged at the closed end 12. In the exemplary embodiment shown, the base 3 is designed as a flat base. However, the design is merely illustrative.

The shell 2 is formed in certain embodiments in particular by overlapping and sealing two side edges of a flat blank, in particular by rolling. The rolled and sealed side edges in certain embodiments are then flattened in further stages. Sealing and/or flattening is carried out in certain embodiments in particular by means of ultrasound.

The base 3 is inserted into the shell 2, as shown schematically in FIG. 1. In the context of the application, “inserting the base” refers both to inserting the base 3 into a preformed shell 2 and to folding a blank for the shell 2 around the preformed, in particular circular, base 3 to form the truncated cone-shaped or sleeve-shaped shell 2.

The opening 11 can be sealed with a lid not shown in FIG. 1. To connect the lid to the container 1, the shell 2 has a flange section 20 at the opening 11, which in the exemplary embodiment shown is particularly circumferential. The flange section 20 is multi-layered, in particular three-layered in the exemplary embodiment shown. In other embodiments, a two-layered flange section 20 or a flange section 20 with more than three layers is provided.

A surface of the flange section 20 pointing away from the closed end 12 serves as a sealing surface 200.

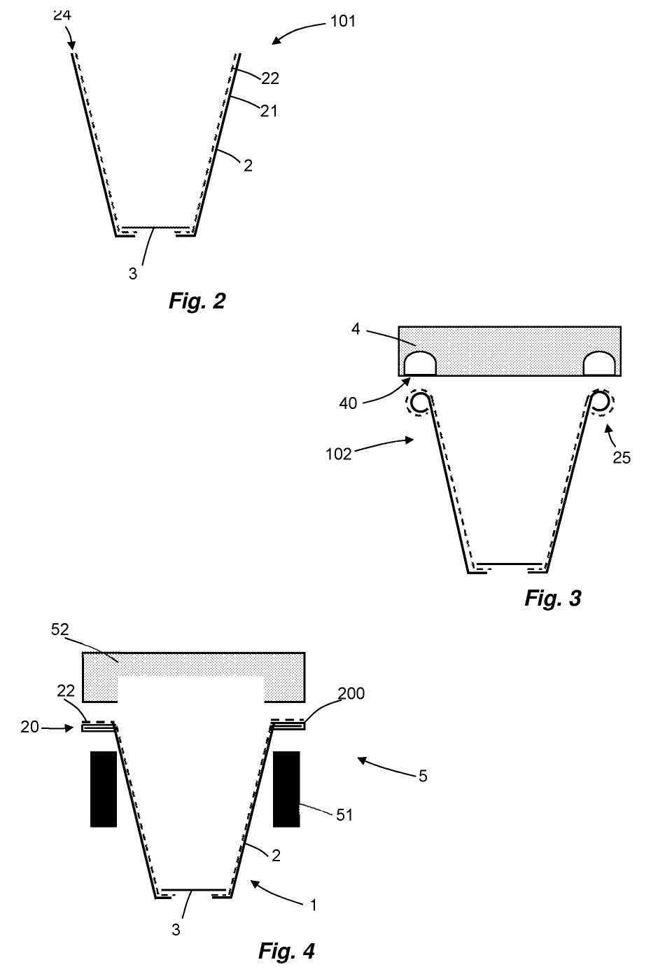

As shown in FIGS. 2 through 4 below, the flange section 20 is formed by rolling outward a free edge section of the shell 2 opposite the base 3 and then pressing it flat.

FIG. 2 shows an initial intermediate product 101 in the manufacture of the container 1 according to FIG. 1 after the shell 2 has been formed and the base 3 has been inserted into the shell 2.

After or during insertion of the base 3 into the shell 2, one end of the shell 2 is folded over in the direction of the base 3 and connected to the base 3 in a material-locking manner, in particular sealed.

As shown schematically in FIG. 2, a material for manufacturing the shell 2 is multi-layered in certain embodiments and comprises at least a first layer 21 and a second layer 22 shown in dashed lines.

The first layer 21 is made of a fibrous material, for example cellulose, wood pulp, and/or waste paper, in particular paper and/or cardboard. In certain embodiments, it has in particular a thickness of 110 to 350 µm.

The second layer 22 serves as a sealing layer 22. The sealing layer 22 is made of a material suitable for sealing. In particular, in certain embodiments, the sealing layer 22 is made of a biodegradable plastic and/or a bio-based plastic.

The shell 2 is sealed to the base 3 by the sealing layer 22. The sealing layer 22 is heated and activated, particularly in the region of the base 3, for sealing with the base 3 using a tool (not shown) applied from the outside or inside.

The fiber-based material for the shell 2 comprises further layers in certain embodiments, in particular single-layered or multi-layered barrier layers, which serve as oxygen, grease, oil, and/or water barriers depending on the contents of container 1 to be packaged.

FIG. 3 shows a second intermediate product 102 in the manufacture of the container 1 according to FIG. 1 after rolling a free end 24 (see FIG. 1) of the shell 2 outward so that a spiral winding 25 is formed at the free end 24. Rolling is performed, for example, using a rolling tool 4 shown schematically in FIG. 3. The rolling tool 4 has an annular groove 40 into which the free end 24 of the shell 2 is inserted for rolling. The groove 40 is designed to be suitable for the specific application. In certain embodiments, the free end 24 is rolled outward in several steps, using the same or different rolling tools 3.

At least one rolling tool 3 or at least one of the multiple rolling tools 3 is heated in certain embodiments, in particular to a temperature of approx. 40°C up to a maximum temperature that is lower than the glass transition temperature of the sealing layer, in particular lower than 80°C. The sealing layer 22 thus softens during the forming of the sealing layer, but does not melt, i.e., the sealing layer 22 is not activated during the forming of the spiral winding 25.

Alternatively or additionally, in certain embodiments, an ultrasonic sonotrode (not shown) is provided for applying ultrasonic vibrations to the rolling tool 3, and/or the rolling tool 3 is designed as an ultrasonic sonotrode. In this process, the free end of the shell 24 is subjected to ultrasonic vibrations for rolling in, either alternatively or in addition to heating. The ultrasonic sonotrode is used to apply longitudinal ultrasonic vibrations in the direction of a longitudinal axis of the shell 2. The applied ultrasonic vibrations heat the free end 24 of the shell 2, enabling easy forming in a single step, also referred to as “in one go”.

The spiral winding 25 produced comprises only one turn in certain embodiments as shown schematically. In other embodiments, the generated spiral winding comprises more than one turn, in particular 1.25 turns or 1.5 turns.

FIG. 4 schematically shows flattening of the spiral winding 25 produced at the free end (see FIG. 3). Flattening is performed using an ultrasonic device 5 with an ultrasonic sonotrode 51 fed from the direction of the base 3 and an anvil 52 that interacts with it. The ultrasonic sonotrode 51 and the anvil 52 are arranged on the opposite side of the flange section 20 to be formed. Using the ultrasonic sonotrode 51, longitudinal ultrasonic vibrations are applied in particular in the direction of a longitudinal axis of the shell 2 to the spiral winding 51 to be flattened. By feeding the ultrasonic sonotrode 51 from the base 3, it is possible to flatten the spiral winding 25, wherein only the sealing layer 22 on one side of the spiral winding 25 facing the ultrasonic sonotrode 51 and within the spiral winding 25 is activated. The activated sealing layer 22 within the spiral winding 51 serves to fix the flange section 20 in place.

A section of the sealing layer 22 facing the anvil 52 is not activated during flattening. In other words, the sealing layer 22 remains intact or preserved on the sealing surface 200. The sealing layer 22 on the sealing surface 200 can be used for the subsequent attachment of a lid (not shown).

In the exemplary embodiment shown, at least the shell 2 is made of a fiber-based material. In certain embodiments, the base 3 and the shell 2 are made of a fiber-based material. The base 3 and the shell 2 can be made of the same or different fiber-based materials.

In the exemplary embodiment shown, the base 3 is inserted before the flange section 20 is formed and connected to the shell 15. In other embodiments, the base 3 is inserted after the flange section has been formed. The terms “open end 10” and “closed end 12” are used in relation to the container 1 to be manufactured. It is obvious that when the base 3 is inserted after the flange section 20 has been formed, the “closed end 12” is initially still open during the manufacture of the container 1. Similarly, after attaching the lid (not shown), the “open end 10” of the container 1 is closed.

The flange section is flattened in certain embodiments in overhead configurations, wherein a shell 2 with the spiral winding 25 formed thereon is placed on the anvil 52 so that a closed end 12 of the container 1 (with or without the inserted base 3) points upward. In certain embodiments, the anvil 52 features a support body that is inserted into the shell 2. The ultrasonic sonotrode 51 can then be fed in from above.

What is claimed is:

1. A method for manufacturing a container with a shell made of a fiber-based material, wherein the container has an open end with an opening and a closed end, and wherein a flange section with a sealing surface is formed on the shell at the open end, comprising the steps:
(a) preforming the flange section by forming a spiral winding by rolling a free edge section of the shell outward, and
(b) finishing the flange section by flattening the spiral winding while applying ultrasonic vibrations with an ultrasonic device comprising an ultrasonic sonotrode and an anvil,
wherein the ultrasonic sonotrode for flattening the spiral winding is arranged on a side of the spiral winding in the direction of the closed end, and the anvil is arranged on an opposite side of the spiral winding.

2. The method according to claim 1, wherein the shell is made of a multi-layered material comprising at least a first layer of a fibrous material and a sealing layer, wherein the sealing layer is arranged on an inner side of the shell, wherein the sealing layer is activated in an inner region when the spiral winding is flattened and remains in a region of the sealing surface.

3. The method according to claim 1, wherein the preforming of the flange section is carried out while applying ultrasonic vibrations.

4. The method according to claim 1, wherein the preforming of the flange section is carried out with a heated rolling tool, wherein the rolling tool is heated in particular to a temperature of approx. 40° to a maximum temperature which is lower than a glass transition temperature of the sealing layer, in particular lower than approx. 80°.

5. The method according to claim 1, wherein the shell is of truncated-cone or sleeve-shape and is formed by overlapping and sealing two side edges of a flat blank.

6. A device for manufacturing a container with a shell made of a fiber-based material, wherein the container has an open end with an opening and a closed end, wherein the shell has a flange section with a sealing surface at the open end of the container, the device comprising an ultrasonic device with an ultrasonic sonotrode and an anvil, wherein the ultrasonic device is designed to apply ultrasonic vibrations to the spiral winding for finishing the flange section by flattening the spiral winding,
wherein the ultrasonic device is designed such that the ultrasonic sonotrode for flattening the spiral winding is arranged on a side of the spiral winding in the direction of the closed end and the anvil is arranged on an opposite side of the spiral winding.

7. The device according to claim 6, wherein the shell is made of a multi-layered material comprising at least a first layer of a fibrous material and a sealing layer, wherein the sealing layer is arranged on an inner side of the shell, wherein the ultrasonic device is designed so that the sealing layer can be activated in an inner region when the spiral winding is flattened and remains in a region of the sealing surface.

8. The device according to claim 6, wherein the device comprises at least one rolling tool for forming the spiral winding.

9. The device according to claim 8, wherein the at least one rolling tool is designed as an ultrasonic sonotrode and/or is coupled to an ultrasonic sonotrode.

10. The device according to claim 8, wherein a heating device is provided for heating the at least one rolling tool, wherein the heating device is designed to heat the rolling tool in particular to a temperature of approx. 40°C up to a maximum temperature that is lower than the glass transition temperature of the sealing layer, in particular lower than approx. 80°.
